(19) United States
(12) Patent Application Publication
(10) Pub. No.: US 2003/0154716 A1
(43) Pub. Date: Aug. 21, 2003

(54) Exhaust gas recirculation system

(75) Inventor: Fabien G. Redon, Farmington Hills, MI (US)

Correspondence Address: BROOKS & KUSHMAN, 1000 TOWN CENTER 22ND FL, SOUTHFIELD, MI, 48075

(73) Assignee: Detroit Diesel Corporation, Detroit, MI

(21) Appl. No.: 10/080,218

(22) Filed: Feb. 21, 2002

(51) Int. Cl. F02B 33/44

(52) U.S. Cl. 60/605.2

(57) ABSTRACT

An exhaust gas recirculation (EGR) system and method for simple and rapid introduction of EGR gas to an internal combustion engine include a pump, tank, and valve connected to the engine. Exhaust gas is pressurized by operation of the pump under predetermined operating conditions and stored in the tank. The valve is selectively controlled to meter amounts of the EGR gas to the engine. The EGR tank can be separate or integrally formed within tubing used to direct EGR gas flow.

### BACKGROUND OF THE INVENTION

1. Field of the Invention

The present invention relates to exhaust gas recirculation (EGR) systems for rapid introduction of EGR gas to an internal combustion engine.

2. Background Art

The combustion process of internal combustion engines produces various emissions which may be regulated, including oxides of nitrogen (Noₓ). Reducing temperatures within a combustion chamber of the engine can help reduce the production of NOₓ.

One way in which the temperatures can be lowered is to meter amounts of exhaust gas back to the engine, or even individual intake ports of the engine, with an exhaust gas recirculation (EGR) system. In order for the EGR gas to flow toward the engine, the EGR gas must have a pressure greater than the fresh air being simultaneously delivered to the engine. In response, some EGR systems include a pump for raising the EGR gas pressure. Most of these systems, however, either experience a detrimental amount of lag time from a request for EGR gas to its deliverance or include relatively complex arrangements for delivering EGR gas to the engine's intake ports. Accordingly, there exists a need to provide a simple EGR system for rapid introduction of EGR gas to an internal combustion engine.

### SUMMARY OF THE INVENTION

The present invention provides an exhaust gas recirculation (EGR) system for rapid introduction of EGR gas to an internal combustion engine.

In one embodiment, the EGR system includes an EGR pump, an EGR tank (that may be an expanded portion of EGR tubing or conduit), and an EGR valve connecting to a turbocharged engine. Exhaust gas is pressurized by the pump and stored in the tank. The valve then can be selectively controlled to meter amounts of the pressurized EGR gas to the intake manifold of the engine. A check valve can be inserted between the pump and tank to prevent pressurized EGR gas from back flowing through the pump. The check valve can also be used in conjunction with the EGR valve to deliver pressurized EGR gas when the pump is inactive. A heat exchanger may be located downstream of the pump, and even downstream of the EGR valve, to ameliorate various adverse effects of EGR gas condensation.

In one embodiment of the present invention, a controller interacts with the EGR system to control the pump, EGR valve, and various other components. The controller can include a microprocessor, or the like, which interacts with sensors located within the EGR system for collecting data on various operating parameters of the engine and EGR system. The data can then be used when controlling the EGR pump, valve, and engine. The controller can also include a computer readable storage medium for storing data representing calibrations and instructions for controlling the EGR system.

### BRIEF DESCRIPTION OF THE DRAWINGS

FIG. 1 illustrates one embodiment of an exhaust gas recirculation (EGR) system for rapid introduction of EGR gas to an intake manifold of an internal combustion engine in accordance with the present invention;

FIG. 2 illustrates another embodiment of an EGR system for rapid introduction of EGR gas to an internal combustion engine including a check valve in accordance with the present invention;

FIG. 3 illustrates another embodiment of an EGR system for rapid introduction of EGR gas to an internal combustion engine including a heat exchanger positioned downstream of the valve in accordance with the present invention; and

FIG. 4 illustrates operation of a system or method for recirculating exhaust gas to the intake manifold of an internal combustion engine in accordance with the present invention.

### DETAILED DESCRIPTION OF THE PREFERRED EMBODIMENT(S)

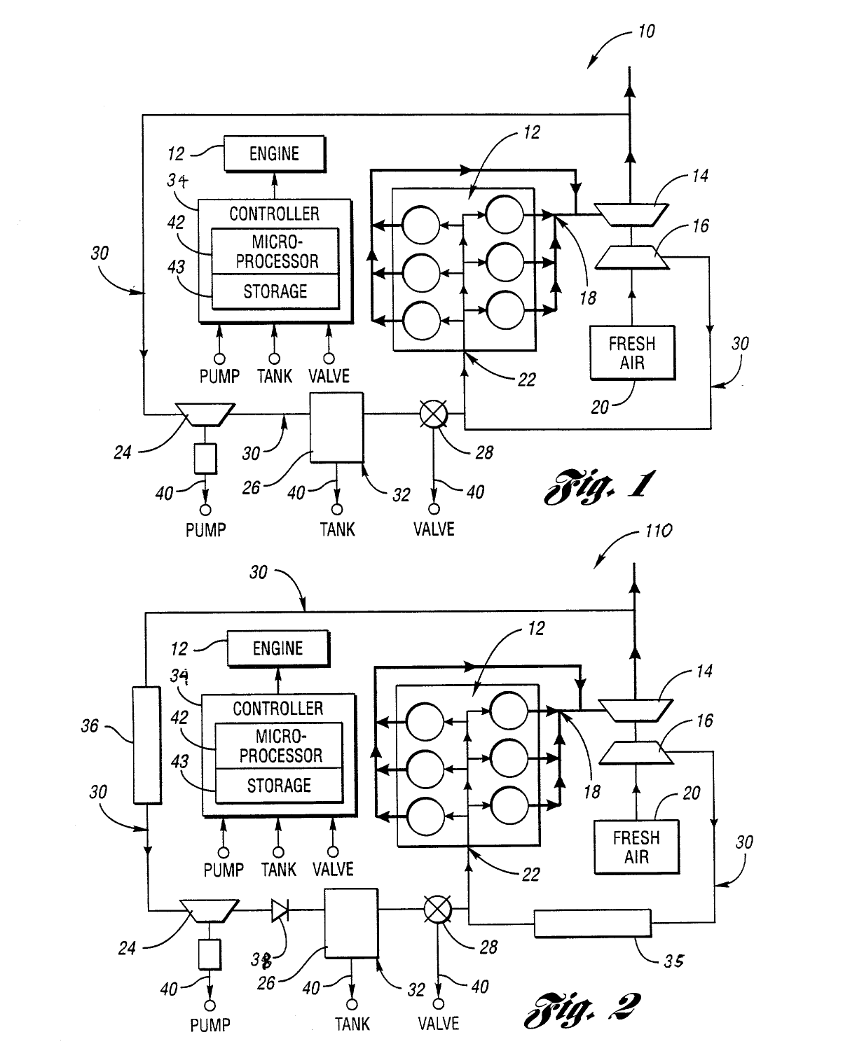

FIG. 1 illustrates an exhaust gas recirculation (EGR) system 10 for rapid introduction of EGR gas to an internal combustion engine 12 in accordance with the present invention. As depicted, engine 12 is a turbocharged engine having a turbine 14 and compressor 16, which are preferably components of a variable geometry turbocharger. Exhaust gas exits exhaust manifold 18 and flows through turbine 14 to drive compressor 16, with turbine 14 and compressor 16 typically mounted on a common shaft. Compressor 16 then pressurizes air from fresh air source 20 for supply to an intake manifold 22.

According to one embodiment of the present invention, EGR system 10 includes a pump 24, tank 26, and valve 28. As shown in FIG. 1, pump 24 is located downstream of turbine 14 and receives exhaust gas through tubing or conduit structure 30. Pump 24 can be driven in any known manner to pressurize the exhaust gas from a first pressure to a second higher pressure. For example, pump 24 can be electrically, hydraulically, or mechanically driven. The EGR gas pressure should be monitored so that the stored pressure is sufficient to introduce the EGR gas to intake manifold 22 in the presence of the pressurized fresh air.

Tank 26 is located downstream of pump 24 and stores the pressurized EGR gas. Tank 26 may be a separate component or integrally formed within tubing 30 by expanding a portion 32 of the tubing structure 30 to retain a greater volume of gas than the predominant or nominal diameter of tubing structure 30. Expanded portion 32 can be formed by stretching tubing structure 30 in any known manner. Alternatively, expanded portion 32 can be a separate volume interconnected with tubing structure 30. By storing the pressurized EGR gas in tank 26, lag time between a request for EGR gas and its delivery to the intake manifold and cylinders can be reduced (improved). For example, time associated with pressurizing and delivering EGR gas in response to a command is reduced by the present invention because the pressurized EGR gas is already stored in tank 26 for rapid delivery. The volume of EGR gas stored in tank expanse 32 is sufficient to store enough pressurized gas that by the time the stored EGR gas is depleted, pump 24 is already providing a sufficient supply of pressurized EGR gas. It is, however, desirable to monitor the pressure of EGR gas in tank 26 or portion 32 using an associated sensor as describe below to provide appropriate control of pump 24. As may be appreciated, unnecessary operation of pump 24 may result in reduced fuel economy. Similarly, insufficient operation of pump 24 would not provide the necessary volume of pressurized EGR gas for faster response according to the present invention.

Advantageously, system 10 is less complex than some prior art approaches in that only one EGR valve 28 is needed. As shown, valve 28 is located downstream of tank 26 to selectively introduce EGR gas to intake manifold 22. Intake manifold 22 then distributes the received EGR gas to the intake ports. Introducing EGR gas into the intake manifold, rather than directly into each cylinder, may be advantageous in providing a consistent homogeneous mixture to all cylinders due to the additional opportunity for mixing of the EGR gas and compressed intake air. In addition, providing EGR gas to the intake manifold, which is located downstream of the turbocharger compressor, does not expose the compressor to adverse effects, such as reduced efficiency associated with excessive heating or corrosion associated with contact with the EGR gas and/or condensate.

Depending on the particular application, EGR valve 28 may be an electric or pneumatic valve which may be an on/off valve or proportional valve. On/off valves may be modulated to provide performance similar to that of a proportional valve, depending upon the response time of the valve and desired modulation rate. In the illustrated embodiment, when EGR valve 28 is in the opened position (or modulated with some duty cycle), pressurized EGR gas is introduced to the fresh air stream within the intake manifold and delivered to engine 12. The EGR gas pressure stored in tank 26 should be monitored using an appropriate sensor and compared to the pressure of the delivered fresh air 20 to insure the EGR gas flows out of valve 28 and into manifold 22 with the fresh air. Turbo boost pressure may be used to provide an indication of intake manifold pressure, for example. In the closed position, valve 28 acts as a flow stop for sealing tank 26.

A controller 34 is connected to system 10 in a conventional manner. A number of sensors and actuators, indicated generally by reference numeral 40, are located throughout system 10. Preferably, sensors and actuators 40 include a sensor for monitoring stored EGR pressure in tank 26 (or conduit portion 32) and actuators for controlling pump 40 and EGR valve 28. Other sensors which may be used to determine current engine or vehicle operating conditions may include an EGR flow rate sensor, throttle position sensor, turbo boost pressure sensor, ambient air temperature sensor, engine coolant temperature sensor, etc. Using a microprocessor 42, or the like, to assimilate the collected data, controller 34 can perform a number of functions, including controlling pump 24, valve 28, and more generally engine 12. Controller 34 preferably includes computer-readable storage media, indicated generally by reference numeral 43 for storing data representing instructions executable by a computer to control engine 12. Computer-readable storage media 43 may also include calibration information in addition to working variables, parameters, and the like. In one embodiment, computer-readable storage media 43 include a random access memory (RAM) in addition to various non-volatile memory such as read-only memory (ROM), and keep-alive memory (KAM). Computer-readable storage media 43 communicate with microprocessor 42 and input/output (I/O) circuitry via a standard control/address bus. As will be appreciated by one of ordinary skill in the art, computer-readable storage media 43 may include various types of physical devices for temporary and/or persistent storage of data which include solid state, magnetic, optical, and combination devices. For example, computer readable storage media 43 may be implemented using one or more physical devices such as DRAM, PROMS, EPROMS, EEPROMS, flash memory, and the like. Depending upon the particular application, computer-readable storage media 43 may also include floppy disks, CD ROM, and the like.

In a typical application, controller 34 processes inputs from the engine sensors and vehicle sensors/switches by executing instructions stored in computer-readable storage media 43 to generate appropriate output signals for control of engine 12. Controller 34 may include instructions for automatically assimilating data and controlling EGR system 10 so that EGR gas storage pressure can be controlled to provide sufficient EGR flow for current engine operating conditions.

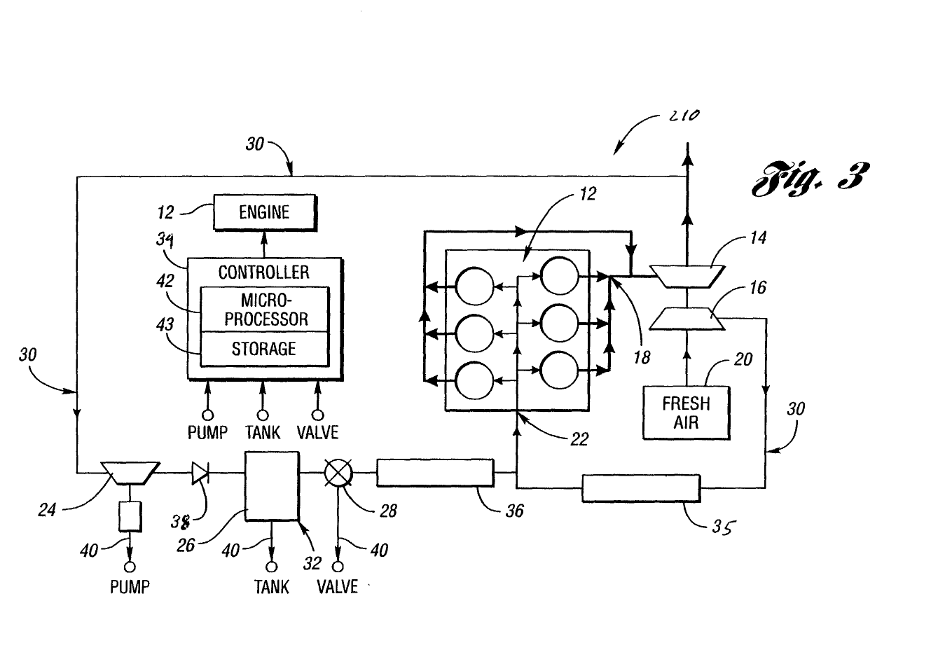

FIG. 2 illustrates another EGR system 110 for rapid introduction of EGR gas to engine 12. System 110 includes a check valve 38 being disposed between pump 24 and tank 26. Check valve 38 allows the EGR gas to flow downstream from pump 24 to tank 26, but prevents the EGR gas from flowing upstream from tank 26 to pump 24. Likewise, sufficient exhaust pressure will “automatically” charge or pressurize the storage portion or tank 26 when pump 24 is inactive with check valve 38 acting as a flow stop to prevent unused EGR gas from being exhausted when the exhaust pressure is subsequently lowered. Check valve 38 allows EGR gas to be stored and then subsequently introduced to engine 12 when pump 24 is inactive. Additionally, FIG. 2 illustrates a common arrangement for heat exchangers 35, 36 being interconnected with the tubing structure 30 for lowering air-flow temperatures. In the example illustrated in FIG. 2, a charge air cooler 35 is provided for lowering the temperature of compressed intake air from compressor 16 and an EGR cooler 36 is provided for lowering the temperature of EGR gas from the outlet of turbine 14 before being introduced to the intake manifold.

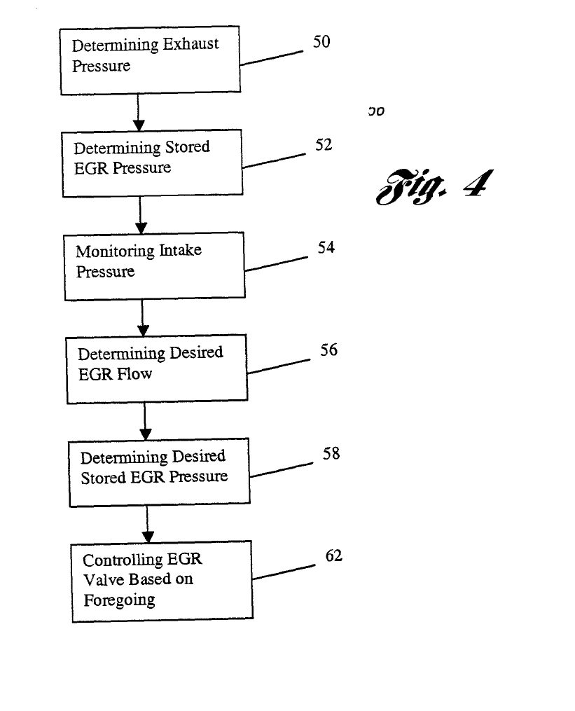

FIG. 3 illustrates yet another EGR system 210 for rapid introduction of EGR gas to engine 12 with heat exchanger 36 being located downstream of valve 28. Locating heat exchanger 36 downstream from pump 24, and even downstream of valve 28 as illustrated in FIG. 3, avoids introduction of any condensation which may occur due to excessive cooling of the EGR gas within heat exchanger 36. In general, condensation has an adverse effect on pump efficiency and EGR gas condensation in particular may also result in corrosion and premature degradation of various pump components. As such, the arrangement of components as illustrated in FIG. 3 can result in an increased efficiency and life of pump 24.

FIG. 4 provides a block diagram illustrating operation of one embodiment for a system or method for controlling exhaust gas recirculation according to the present invention. As will be appreciated by one of ordinary skill in the art, the block diagram of FIG. 4 represents control logic which may be implemented or effected in hardware, software, or a combination of hardware and software. The various functions are preferably effected by a programmed microprocessor, such as included in the DDEC controller manufactured by Detroit Diesel Corporation, Detroit, Mich. Of course, control of the engine/vehicle may include one or more functions implemented by dedicated electric, electronic, or integrated circuits. As will also be appreciated by those of skill in the art, the control logic may be implemented using any of a number of known programming and processing techniques or strategies and is not limited to the order or sequence illustrated in FIG. 4. For example, interrupt or event driven processing is typically employed in real-time control applications, such as control of an engine or vehicle rather than a purely sequential strategy as illustrated. Likewise, parallel processing, multi-tasking, or multi-threaded systems and methods may be used to accomplish the objectives, features, and advantages of the present invention. The invention is independent of the particular programming language, operating system, processor, or circuitry used to develop and/or implement the control logic illustrated. Likewise, depending upon the particular programming language and processing strategy, various functions may be performed in the sequence illustrated, at substantially the same time, or in a different sequence while accomplishing the features and advantages of the present invention. The illustrated functions may be modified, or in some cases omitted, without departing from the spirit or scope of the present invention.

In various embodiments of the present invention, the control logic illustrated is implemented primarily in software and is stored in computer readable storage media within the ECM. As one of ordinary skill in the art will appreciate, various control parameters, instructions, and calibration information stored within the ECM may be selectively modified by the vehicle owner/operator while other information is restricted to authorized service or factory personnel. The computer readable storage media may also be used to store engine/vehicle operating information for vehicle owners/operators and diagnostic information for maintenance/service personnel. Although not explicitly illustrated, various steps or functions may be repeatedly performed depending on the type of processing employed.

Block 50 of FIG. 4 represents determination of exhaust pressure. Exhaust pressure may be determined using a back pressure sensor or may be inferred based on various engine operating parameters. Stored EGR pressure is determined as represented by block 52 using a corresponding sensor. As described above, the pressurized EGR may be stored in a tank or an expanding portion of the EGR conduit which functions as a tank with a pressure sensor located accordingly. Block 54 represents monitoring the intake pressure, which may determined using one or more pressure sensors. For example, an ambient barometric pressure sensor may be used in conjunction with a turbocharger boost sensor to determine the intake pressure. A desired EGR flow is then determined based on current engine operating conditions as represented by block 56. The desired EGR flow may be determined using one or more look-up tables alone or in combination with one or more equations or functions. Depending upon the particular application and calibration, a desired value for the stored EGR pressure may be determined based on the current engine operating conditions or parameters as represented by block 58. The desired stored EGR pressure may alternatively be a fixed calibratable value that does not depend upon the current operating conditions. Operation of the EGR pump is then controlled based on at least one of the above parameters including exhaust pressure, stored EGR pressure, intake pressure, and EGR flow, as generally represented by block 60, such that the EGR valve may deliver the desired EGR flow with reduced delay.

In one embodiment, the pump is controlled to maintain the stored EGR pressure above a set point value which may be fixed or determined based on the desired EGR flow, current exhaust pressure and current intake pressure. Of course, other engine or vehicle operating parameters may be used to provide a suitable indication for operating the EGR pump. For example, engine speed, throttle position and/or temperature (ambient, coolant, fuel, oil, etc.) may be used to control the desired minimum pressure value for stored EGR. In this embodiment, the EGR pump is activated when the stored EGR pressure falls below the corresponding set point and is deactivated when the stored EGR pressure rises above the set point plus some hysteresis value without regard to the exhaust pressure or intake pressure.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An exhaust gas recirculation (EGR) system for introduction of EGR gas to a turbocharged internal combustion engine, the system comprising:
an EGR pump located downstream from a turbine of the turbocharged engine for pressurizing EGR exhaust gas received from the turbine;
an EGR tank for storing pressurized exhaust gas; and
an EGR valve to introduce stored EGR gas to an intake manifold that then delivers the introduced EGR gas to intake ports of the engine.

2. The system of claim 1, wherein the EGR tank corresponds to an expansively larger integral portion of a tubing structure used to direct the EGR gas.

3. The system of claim 1, wherein the EGR tank is a separate component interconnected with the tubing structure.

4. The system of claim 2, wherein the EGR pump pressurizes the EGR gas to a pressure greater than the pressure of fresh being simultaneously supplied to the intake manifold by a compressor of the turbocharged engine.

5. The system of claim 1, further comprising a controller for controlling pressure within the EGR pump tank, EGR valve, and engine.

6. The system of claim 5, wherein the controller includes a microprocessor for collecting data from a number of sensors monitoring various parameters of the engine and EGR system.

7. The system of claim 1, further comprising a check valve disposed downstream of the EGR pump and upstream from the EGR tank to prevent the EGR gas from flowing from the EGR tank back through the EGR pump.

8. The system of claim 7, wherein the check valve allows for introduction of EGR gas to the engine when the pump is inactive.

9. The system of claim 1, further comprising at least one heat exchanger being located downstream from the EGR pump.

10. The system of claim 1, further comprising a controller including a computer readable storage medium having executable instructions thereon for monitoring and controlling the system.

11. An exhaust gas recirculation (EGR) method for metering EGR gas to a turbocharged engine, the method comprising:
receiving EGR gas from a turbine of the turbocharged engine;
pressurizing the received EGR gas;
storing the pressurized EGR gas in an EGR tank; and
controlling an EGR valve to introduce the stored EGR gas to an intake manifold of the engine that then delivers the EGR gas to intake ports of the engine.

12. The method of claim 11, further comprising controlling the EGR valve to introduce the stored EGR gas when the EGR pump is inactive.

13. The method of claim 11, further comprising cooling the EGR gas downstream of the EGR pump.

14. The method of claim 11, further comprising storing the pressurized gas in an expansively larger portion integral within a tubing structure used to direct the EGR gas.

15. A method for controlling exhaust gas recirculation (EGR) in a multi-cylinder internal combustion engine having an EGR circuit for redirecting a portion of exhaust gas downstream from a turbocharger to an EGR pump and pressurized EGR gas storage area, the engine including a single EGR valve for selectively delivering stored EGR gas to an intake manifold upstream of cylinder intake ports, the method comprising:
determining a desired stored EGR pressure based on current engine operating conditions; and
controlling the EGR pump based on the desired stored EGR pressure.

16. The method of claim 15 wherein the desired stored EGR pressure is a programmable constant value.

17. The method of claim 15 wherein the desired stored EGR pressure is determined based on at least one of exhaust pressure, intake pressure, and desired EGR flow.

18. The method of claim 15 further comprising:
measuring an actual stored EGR pressure, wherein the step of controlling comprises controlling the EGR pump to reduce the error between the actual and desired stored EGR pressures.

19. A computer readable storage medium having stored data representing instructions executable by a computer for controlling exhaust gas recirculation (EGR) in a multi-cylinder internal combustion engine having an EGR circuit for redirecting a portion of exhaust gas downstream from a turbocharger to an EGR pump and pressurized EGR gas storage area, the engine including a single EGR valve for selectively delivering stored EGR gas to an intake manifold upstream of cylinder intake ports, the computer readable storage medium comprising:
instructions for determining a desired stored EGR pressure based on current engine operating conditions; and
instructions for controlling the EGR pump based on the desired stored EGR pressure.

20. The computer readable storage medium of claim 19 wherein the desired stored EGR pressure is a programmable constant value.

21. The computer readable storage medium of claim 15 wherein the instructions for determining a desired stored EGR pressure comprise instructions for determining a desired stored EGR pressure based on at least one of exhaust pressure, intake pressure, and desired EGR flow.

22. The computer readable storage medium of claim 15 further comprising:
instructions for determining an actual stored EGR pressure, wherein the instructions for controlling comprise instructions for controlling the EGR pump to reduce the error between the actual and desired stored EGR pressures.
